(19) United States
(12) Patent Application Publication
(10) Pub. No.: US 2018/0348091 A1
(43) Pub. Date: Dec. 6, 2018

(54) DEVICE AND METHOD FOR THE PRODUCTION OF AERODYNAMICALLY STABILIZED, ELECTRIFIED MICROSCOPIC JETS FOR THE TRANSPORT OF SAMPLES

(71) Applicants: UNIVERSIDAD DE SEVILLA, Sevilla (ES); DEUTSCHES ELEKTRONEN-SYNCHROTRON, Hamburg (DE)

(72) Inventors: Alfonso Miguel GAÑÁN CALVO, Sevilla (ES); Francisco CRUZ MAZO, Sevilla (ES); Antonio Jesús DÍAZ QUINTANA, Sevilla (ES); Irene DÍAZ MORENO, Sevilla (ES); Braulio GAÑÁN RIESCO, Camas (ES); Max Oliver WIEDORN, Hamburg (DE); Henry CHAPMAN, Hamburg (DE); Sasa BAJT, Hamburg (DE)

(21) Appl. No.: 15/996,225

(22) Filed: Jun. 1, 2018

(30) Foreign Application Priority Data
Jun. 2, 2017 (EP) 17382333

(51) Int. Cl. G01N 1/00

(52) U.S. Cl. CPC G01N 1/00; G01N 2001/002

(57) ABSTRACT

The present disclosure relates to a device for the transport of biological or other samples and for analysis thereof by interaction with a pulsed and focused energy beam, comprising: a transport capillary configured to house transport liquid, configured with an outlet section; a nozzle disposed concentrically and externally to the transport capillary, wherein said nozzle comprises a discharge section; and wherein the space between the transport capillary and the nozzle is configured to house a stabilizing gas; at least a first electrode for connecting a voltage to the transport liquid, in turn connected to a second electrode arranged at the outlet of the transport liquid capillary and the nozzle wherein said electrodes are subjected to an electrical potential difference. The disclosure also relates to a method comprising the use of said device.

### RELATED APPLICATION

Any and all applications for which a foreign or domestic priority claim is identified in the Application Data Sheet as filed with the present application are hereby incorporated by reference under 37 CFR 1.57. This application claims the benefit of European Patent Application No. EP17382333, filed on Jun. 2, 2017, in the European Patent Office, the disclosure of which is incorporated herein in its entirety by reference.

### FIELD

The present disclosure relates to devices and methods for the transport and molecular analysis of samples at very small scales in liquid phase, preferably biological samples, but without limitation to samples of any other nature. Said devices and methods use a microscopic jet of liquid as a carrier of the samples, wherein said jet is generated by combining the application of an electric field and a gas stream around said liquid.

### BACKGROUND

Various technologies for the analysis of biological samples are currently known in the art. They generally comprise the generation of jet streams of nebulization particles, such as those based on “Gas Dynamic Virtual Nozzle” (GDVN) solutions, as described for example in [1] or in [2], which are based on Flow Focusing technologies (see [3]). Other known technologies for this purpose are based on “Lipidic Cubic Phase Injector” (or LCPI) systems, as disclosed in [4].

Although the aforementioned technologies allow the analysis of jets having microscopic scale diameters, they all have a severe limitation when working at smaller scales. This implies, therefore, a restriction as to the type of substances that can be analyzed with the mentioned technologies, not allowing, for instance, to work at nanometric scales, which are of particular interest in certain areas such as the analysis of certain biological samples, due to its special molecular configuration.

The reduction of the diameter of the generated jets also enables the reduction of the scattering background in relation to the diffraction signal from the sample. This background is proportional to the total mass intersected by the pulsed and focused beam of energy used (typically, an X-ray beam). Therefore, it is necessary in the present field to find solutions that allow working with diameters lower than the known ones, thereby significantly reducing the effect of the background noise and, thus, allowing measurements of smaller samples at a given ratio of signal to background.

Specifically, this reduction of scale would allow, in the field of biological analyses, to perform diffraction studies of a single fiber of proteins, fibrils or filaments. As these become aligned with the flow in the jet, the possibility of working with narrower jets would therefore provide a reduction of background derived from the better alignment obtained, which is especially important in this type of studies, since the diffraction of the fiber is, in general, very weak.

Additionally, it is desirable to obtain technical solutions that allow generating velocities of the liquid in the jet much higher than those obtained by other techniques, such as Flow Focusing, GDVN or LCPI. The achievement of high velocities allows increasing the frequency of the performed measurements, resulting in a proportional improvement of the efficiency of these technologies in the analyses carried out, and in particular concerning the use of the sample, which requires much smaller quantities.

The present disclosure solves the aforementioned needs in the state of the art by means of a novel device for the production of aerodynamically stabilized and electrified microscopic jets for the transport of samples, and a method comprising the use of said device.

### REFERENCES

[1] D. P. De Ponte, U. Weierstall, K. Schmidt, J. Warner, D. Starodub, J. C. H. Spence and R. B. Doak, “Gas dynamic virtual nozzle for generation of microscopic droplet streams”. J. Phys. D: Appl. Phys. 41 (2008) 195505.
[2] H. Chapman et al., “Femtosecond X-ray protein nanocrystallography”. Nature 470, 73-78 (2011).
[3] A. M. Gahan-Calvo, “Generation of Steady Liquid Microthreads and Micron-Sized Monodisperse Sprays in Gas Streams”. Phys. Rev. Lett. 80, 285-288 (1998).
[4] U. Weierstall et al., “Lipidic Cubic Phase Injector Facilitates Membrane Protein Serial Femtosecond Crystallography”. Nature Comm. 5, 3309 (1-6) (2014).

### SUMMARY

The present disclosure proposes a method and a device for the molecular analysis of biological samples as well as samples of any other nature, by conveying microscopic amounts of said samples by a high speed liquid microscopic jet acting as a vehicle to a point where said jet with the samples interact with a pulsed and focused beam of high density energy. In particular, such a beam may, for example, come from a Free Electron Laser (FEL) such as the “European XFEL”, the “Linac Coherent Light Source” or the “SwissFEL”, or from a synchrotron-radiation facility.

The proposed disclosure generates a jet having sufficient length, diameter and velocity in order to ensure: (i) that the sequence of beam pulses and their intensity do not disturb the stability of the jet or of the system from which it comes, and (ii) that all pulses interact with the jet under the same conditions. For this purpose, this disclosure employs several elements: (a) a capillary conduit through which a transport liquid or matrix is continuously supplied; (b) said liquid having physical properties (density, viscosity, surface tension, and electrical conductivity) such that the velocity formed by the combination of density, surface tension, electrical conductivity, and vacuum permittivity preferably exceeds 50 meters per second, and the length formed by the viscosity, density and surface tension exceeds 1 micrometer; (c) a shield, funnel or nozzle located concentrically around the capillary, and through which a stabilizing gas stream is supplied, such that the capillary exceeds the outlet of said nozzle; (d) a first electrode connected to the matrix or transport liquid to which an electric potential is applied respect to a second electrode, wherein said second electrode is located at the opposite side of the outlet section of the capillary tube, preferably at a distance H, and so that the applied potential electric has preferably a value between 1 and 4 times the voltage

$${( \frac{σ {D}_{l}}{{ɛ}_{o}} )}^{1 / 2} \times Ln ( \frac{H}{{D}_{l}} ) ,$$

where Ln refers to the natural logarithm; and given the following physical properties of the transport liquid (2): surface tension σ with either its vapor or vacuum, and electrical permittivity of vacuum εₒ, which ensures the formation of a stable microscopic capillary jet of the matrix liquid or transport liquid.

In addition, the sample is either previously added to the transport liquid or introduced into the stream of transport liquid upstream of the outlet of the capillary duct by any method, such as suspending another liquid (liquor) through another capillary conduit discharging into the capillary of the matrix liquid or transport liquid.

As a fundamental feature of this disclosure, the stabilizing gas stream provides the mechanical conditions for forming the stationary and stable microscopic capillary jet so that, in the absence of said gas stream, the necessary conditions for microscopic capillary jet stability would not take place and, as a consequence, it would not be possible to bring the samples to the point of interaction with the energy beam in a continuous, reproducible manner, and with minimal consumption of said samples.

Other fundamental features of this disclosure of particular utility for the indicated application are:
It produces microscopic capillary jets of very low diameter (up to several orders of magnitude lower than the prior art, reaching the nanometric scale), compared to other techniques used for the aforementioned purposes and application.
It allows liquid speeds in the jet much higher than the ones obtained by other techniques such as in GDVN or LCPI. In fact, one can typically exceed speed values of 100 m/s. Also, measurements may be carried out at frequencies higher than 1 MHz. Although the present disclosure is not limited to be used at the European X-ray Free Electron Laser (EuXFEL), which operates with ultra-short pulses (about 10 femtoseconds) and high repetition rate of up to 4.5 MHz, the extreme high rate in measurements and the efficiency in the use of the samples is an essential aspect that the present disclosure solves in combination with said rate of repetition of the energy beam.

As stated, the object of the disclosure refers to a device for sample preparation according to any of the claims. Such object is achieved by the transport of biological or other samples for their analysis, by their interaction with a pulsed and focused energy beam, which advantageously comprises:
a transport capillary configured to receive a transport liquid, configured with an outlet section; with
a nozzle, arranged concentrically and external to the transport capillary, wherein said nozzle comprises a discharge section; and wherein the space between the transport capillary and the nozzle is configured to house a stabilizing gas;
at least one voltage source electrode connected to the transport liquid, and a second opposite electrode connected to another voltage source electrode and arranged at the outlet of the transport liquid capillary and the nozzle, wherein said electrodes are subjected to an electrical potential difference.

In a preferred embodiment of the disclosure, the electrode opposite to the electrode connected to the transport liquid comprises a flat electrode, an annular electrode and/or a circular or conical electrode.

In another preferred embodiment of the disclosure, the device further comprises a sample-housing capillary, concentric and internal to the transport liquid capillary, configured to house a liquid carrying said samples.

In another preferred embodiment of the disclosure, the outlet section of the transport capillary is configured to protrude from the discharge section of the nozzle a distance not greater than five times the opening diameter D_{g} of said discharge section.

Another object of the disclosure relates to a method for the transport of biological or other samples according to any of the claims and for analysis thereof by interaction with a pulsed and focused energy beam, which advantageously comprises the use of a device according to any of the preceding preferred embodiments for the device of the disclosure, and performing at least the following steps:
the samples are introduced into a transport liquid or matrix which is forced to flow continuously through the transporting capillary whose outlet section, with diameter Dₗ, is surrounded concentrically by a funnel or nozzle.
the outlet section of the transport liquid capillary is configured to protrude a distance of no more than five times the opening diameter D_{g} of the discharge section from said nozzle:
given the following physical properties of the transport liquid: surface tension σ with either its vapor or vacuum, electric conductivity κ, density ρ and electrical permittivity of vacuum εₒ, the reference velocity of said transport liquid expressed as

$${( \frac{σκ}{{ρɛ}_{o}} )}^{1 / 3}$$

is equal to or greater than 5.0 meters per second;
given the liquid viscosity μ, the reference length

$$\frac{{μ}^{2}}{ρσ}$$

is equal to or greater than 0.1 micrometer;
a first electrode is connected to the transport liquid, and a second electrode is placed in front of the outlet section of the capillary at a distance H, and a potential difference V between both of them is established between 1 and 4 times the voltage

$${( \frac{σ {D}_{l}}{{ɛ}_{o}} )}^{1 / 2} \times Ln ( \frac{H}{{D}_{l}} ) ,$$

where Ln refers to the natural logarithm;
a flow of liquid is forced through the transport liquid capillary equal to or less than 100000 times the reference flow expressed as

$$\frac{{σɛ}_{o}}{ρκ} ;$$

a stabilizing gas stream is discharged concentrically with the transport liquid through the nozzle;
given the density of the gas ρ_{g}, the speed of the gas ν_{g}, the viscosity of the gas μg and the opening diameter D_{g} of said discharge section, the Reynolds number

$${Re}_{g} = \frac{{ρ}_{g} {v}_{g} {D}_{g}}{{μ}_{g}}$$

is between 0.1 and 5000;
under all of the foregoing conditions the transport liquid forms at the outlet section of the transport liquid capillary a stable conical capillary meniscus from the apex of which emerges a steady and stable microscopic capillary jet that is a vehicle of the samples previously introduced into the transport liquid.

In a preferred embodiment of the disclosure, the reference velocity of said transport liquid (2) expressed as

$${( \frac{σκ}{{ρɛ}_{o}} )}^{1 / 3}$$

is greater than 50.0 meters per second.

In another preferred embodiment of the disclosure, the difference of potential (V) between the electrodes, producing an electric field on the transport liquid, is between 2 and 3 times the voltage

$${( \frac{σ {D}_{l}}{{ɛ}_{o}} )}^{1 / 2} \times Ln ( \frac{H}{{D}_{l}} ) .$$

In another preferred embodiment of the disclosure, wherein a flow of transport liquid through the transport liquid capillary is forced to be less than 500 times the reference flow expressed as

$$\frac{{σɛ}_{o}}{ρκ} .$$

In another preferred embodiment of the disclosure, in the discharge section, the Reynolds number

$${Re}_{g} = \frac{{ρ}_{g} {v}_{g} {D}_{g}}{{μ}_{g}}$$

is less than 1000 and greater than 10.

In another preferred embodiment of the disclosure, given the viscosity p of the transport liquid, the reference length

$$\frac{{μ}^{2}}{ρσ}$$

is equal to or greater than 1 micrometer.

In another preferred embodiment of the disclosure, the samples are introduced into the transport liquid by suspension, solution, or emulsion, either directly or by introducing them previously into another liquid which is subsequently mixed or emulsified in the matrix liquid.

In another preferred embodiment of the disclosure, the samples are continuously introduced into the transport liquid flowing through the capillary, by a sample capillary which discharges the sample carrying liquid into the capillary.

In another preferred embodiment of the disclosure, a defined and convergent stream of the sample carrier liquid is generated which ultimately flows coaxially through the interior of the microscopic stream entrained by the matrix liquid.

### BRIEF DESCRIPTION OF THE DRAWINGS

FIG. 1: General diagram of the device of the disclosure, according to a preferred embodiment thereof, showing the main elements of said device.

FIG. 2: Perspective view of the device of the disclosure, according to a preferred embodiment thereof.

FIG. 3: Micrograph of a preferred embodiment of the device of the disclosure, showing the conical meniscus and the microscopic capillary jet generated in the use of said device.

FIG. 4: Schematic of the device of the disclosure, according to a preferred embodiment thereof based on the use of a conical electrode.

FIG. 5: Schematic of the device of the disclosure, according to a preferred embodiment thereof based on the use of an annular electrode.

FIG. 6: Alternative configuration of introduction of the samples, through a capillary through which a carrier liquid flows, and which discharges into the liquid forming a defined and focused current.

### NUMERICAL REFERENCES USED IN THE DRAWINGS

| | |
|---|---|
| (1) | Samples |
| (2) | Transport liquid or matrix |
| (3) | Transport liquid capillary |
| (4) | Capillary outlet section |
| (5) | Stabilizing gas funnel or nozzle |
| (6) | Discharge section of funnel or nozzle |
| (7) | First voltage connection |
| | electrode to transport liquid |
| (8) | Second electrode opposite to |
| | the transport liquid, with which |
| | a difference of electric |
| | potential (V) is established |
| (9) | Stabilizing gas |
| (10) | Stable conical capillary meniscus |
| (11) | Microscopic stable capillary jet |
| (12) | Sample housing capillary |
| (13) | Sample carrier liquid |

### DETAILED DESCRIPTION

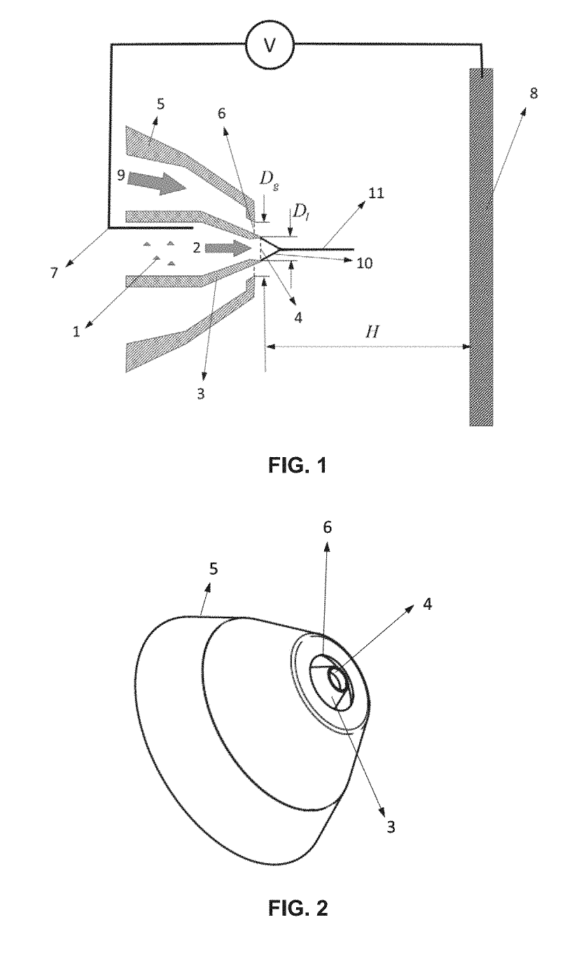

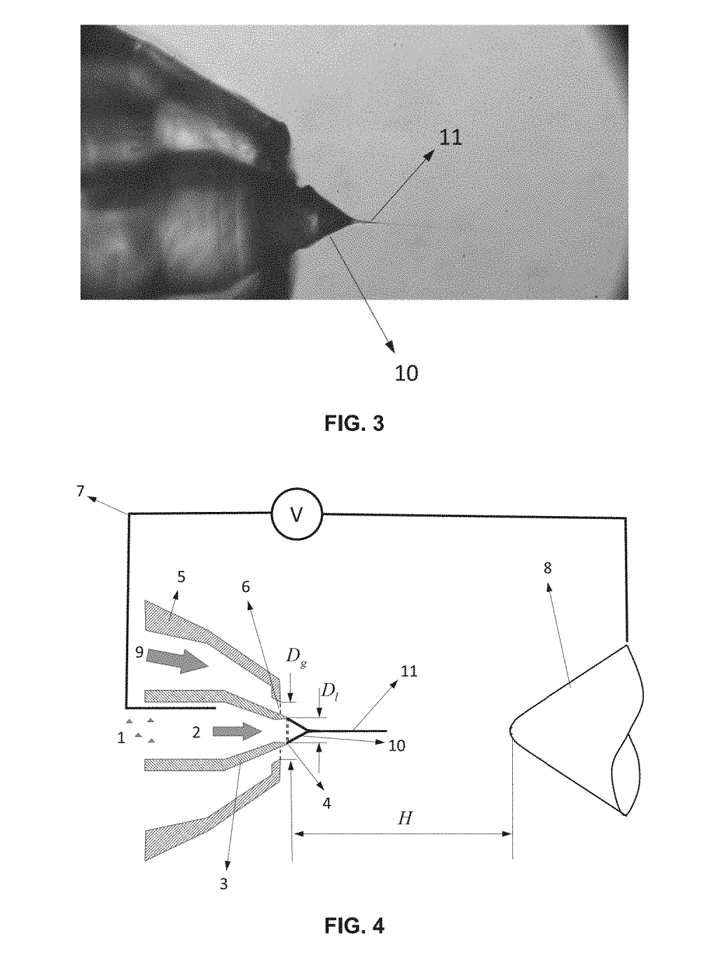

Different examples of preferred embodiments of the present disclosure on are shown in FIGS. 1-6 herein. In said Figures, it is seen how the device of the disclosure for sample (1) transport and analysis device of the disclosure preferably comprises a transport liquid capillary (3) configured to receive transport liquid (2) (or liquid matrix), configured with an outlet section (4) for forming a stable conical capillary meniscus (10), from which emerges a microscopic capillary jet (11) which remains stable and stationary, and which is a vehicle of the samples (1) which have been Introduced into the transport liquid (2) previously. To achieve this effect, the device further comprises a nozzle (5) or funnel arranged concentrically and externally to the transport liquid capillary (3), wherein said nozzle (5) comprises a discharge section (6). The space between the transport liquid capillary (3) and the nozzle (5) is configured to house a stabilizing gas (9).

The device further comprises at least one first electrode (7) for connecting a voltage to the transport liquid (2), and a second opposite electrode (8) arranged at the outlet section (4) of the transport liquid capillary (3) and the nozzle (5), wherein said electrodes (7, 8) are subjected to an electrical potential difference (V).

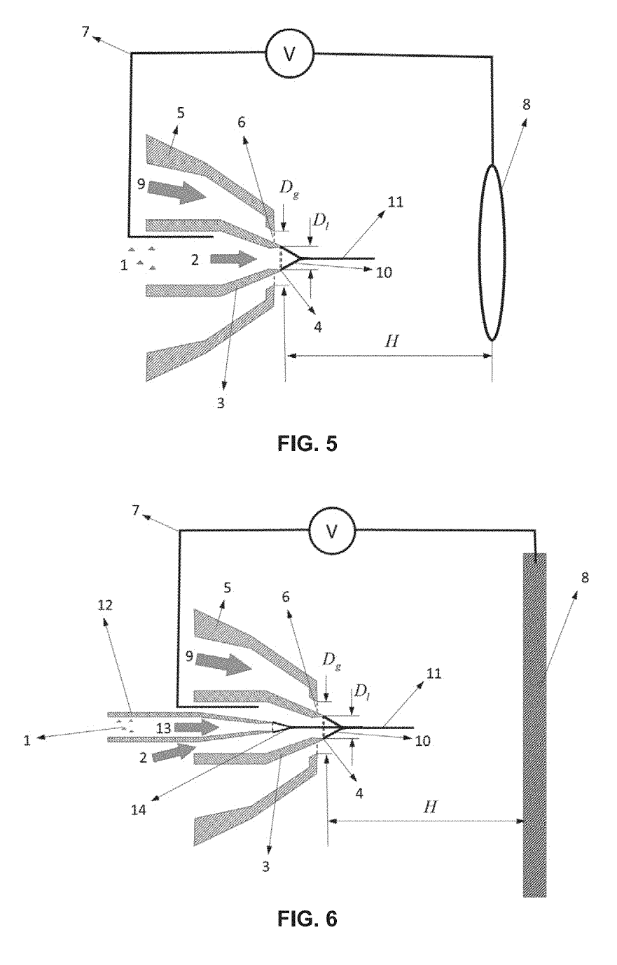

In different preferred embodiments of the disclosure, the second electrode (8) opposite to the electrode (7) connected to the transport liquid (2) may be, for example, a flat electrode (FIG. 1), a conical electrode (FIG. 4), or a circular or annular electrode (FIG. 5). Other electrode forms are equally feasible within the scope of the disclosure.

In another preferred embodiment of the disclosure, the outlet section (4) of the transport liquid capillary (3) is conical (see FIGS. 1-6).

In yet another preferred embodiment of the disclosure, the discharge section (6) of the nozzle (5) is conical (see FIGS. 1-6).

The samples (1) to be transported are preferably housed or introduced by the transport liquid capillary (3) (FIGS. 1, 4 and 5). However, in other preferred embodiments of the disclosure (FIG. 6), the device may comprise a sample housing capillary (12), concentric and internal to the transport liquid capillary (3), configured to house a sample carrier liquid (13) carrying said samples (1).

Another object of the disclosure relates to a process for the transport of biological or other samples and for analysis by interaction with a pulsed and focused beam of energy (for example by means of X-rays). Said method preferably comprises carrying out the following steps:

The samples (1) are introduced into a conveying transport liquid (2) or matrix, which is forced to flow continuously through a transport liquid capillary (3) whose outlet section (4), with diameter Dₗ, is concentrically surrounded by a funnel or nozzle (5).

The outlet section (4) of the transport liquid capillary (3) is configured to protrude a distance of no more than five times the opening diameter D_{g} of the discharge section (6) from said nozzle (5).

Given the following physical properties of the transport liquid (2): surface tension σ with either its vapor or vacuum, electric conductivity κ, density ρ and electrical permittivity of vacuum εₒ, the reference velocity of said transport liquid (2) expressed as

$${( \frac{σκ}{{ρɛ}_{o}} )}^{1 / 3}$$

is equal to or greater than 5.0 meters per second; preferably larger than 50 meters per second.

Given the liquid viscosity μ, the reference length

$$\frac{{μ}^{2}}{ρσ}$$

is equal to or greater than 0.1 micrometer;

A first electrode (7) is connected to the transport liquid (2), and another planar electrode (8) is placed in front of the outlet section (4) of the transport liquid capillary (3) at a distance H, and a potential difference V between both of them is established between 1 and 4 times the voltage

$${( \frac{σ {D}_{l}}{{ɛ}_{o}} )}^{1 / 2} \times Ln ( \frac{H}{{D}_{l}} ) ,$$

preferably between 2 and 3 times the foregoing voltage;

a flow of transport liquid (2) is forced through the transport liquid capillary (3) equal to or less than 100000 times the reference flow expressed as

$$\frac{{σɛ}_{o}}{ρκ} ;$$

preferably less than 15 to 500 times said reference flow rate.

A stream of stabilizing gas (9) is discharged concentrically with the transport liquid (2) through the nozzle (5);

given the density of the gas ρ_{g}, the speed of the gas ν_{g}, the viscosity of the gas μg and the opening diameter D_{g} of said discharge section, the Reynolds number

$${Re}_{g} = \frac{{ρ}_{g} {v}_{g} {D}_{g}}{{μ}_{g}}$$

is between 0.1 and 5000; preferably less than 1000 and greater than 10.

Under all of the above conditions, the transport liquid (2) forms at the outlet section (4) of the transport liquid capillary (3) a stable conical capillary meniscus (10) from the apex of which emerges a microscopic capillary jet (11) which remains stable and stationary, and is a vehicle of the samples (1) which have been introduced into the transport liquid (2) previously.

Preferably, the samples (1) are introduced into the transport liquid (2) by suspension, solution, or emulsion either directly or by previously introducing them into another liquid which is subsequently mixed or emulsified in the transport liquid (2).

In another embodiment of the method of the disclosure, the samples (1) are introduced continuously into the transport liquid (2) flowing through the transport liquid capillary (3), by means of a sample housing capillary (12) discharging the sample carrying liquid (13) inside the transport liquid capillary (3).

In another embodiment of the method of the disclosure, a defined and convergent stream of the sample carrier liquid (13) is generated which finally flows coaxially through the interior of the microscopic capillary jet (11) drawn by the transport liquid (2).

What is claimed is:

1. A device for the production of aerodynamically stabilized, electrified microscopic jets, suitable for the transport of biological or other samples for molecular analysis, wherein the device comprises:
a transport liquid capillary configured to receive a transport liquid, the transport liquid capillary comprising an outlet section, with diameter Dₗ;
a nozzle disposed concentrically and externally to the transport liquid capillary, wherein said nozzle comprises a discharge section; and wherein there is a stabilizing space between the transport liquid capillary and the nozzle configured to house a stabilizing gas; wherein the outlet section of the transport liquid capillary is configured to protrude from the discharge section of the nozzle by a distance not exceeding five times the opening diameter D_{g} of said discharge section;
at least one first electrode configured to provide a voltage to the transport liquid;
a second electrode arranged at the outlet section of the transport liquid capillary at a distance H, and connected to the first electrode;
wherein the density of the stabilizing gas ρ_{g}, the speed of the stabilizing gas ν_{g}, the viscosity of the gas μ_{g} and the opening diameter D_{g} of the discharge section satisfy that the Reynolds number
$${Re}_{g} = \frac{{ρ}_{g} {v}_{g} {D}_{g}}{{μ}_{g}}$$
is between 0.1 and 5000; and
wherein, given the following physical properties of the transport liquid: surface tension σ and electrical permittivity of vacuum εₒ, the device is configured to subject said electrodes to an electrical potential difference (V) between 1 and 4 times the voltage
$${( \frac{σ {D}_{l}}{{ɛ}_{o}} )}^{1 / 2} \times Ln ( \frac{H}{{D}_{l}} ) ;$$
which produces an electric field on the transport liquid emerging from the outlet section sufficient to stretch it in the shape of a stable conical meniscus.

2. The device according to claim 1, wherein the second electrode opposite to the first electrode connected to the transport liquid comprises a flat electrode, an annular or circular electrode and/or a conical electrode.

3. The device according to claim 1, further comprising a sample housing capillary, concentric and internal to the transport liquid capillary, configured to house a sample carrier liquid carrying said samples.

4. A method for the production of aerodynamically stabilized, electrified microscopic jets, suitable for the transport of biological or other samples for molecular analysis; wherein the method comprises the use of a device according to claim 1, and carrying out at least the following steps:
introducing the samples into the transport liquid, which is forced to flow continuously through the transport liquid capillary whose outlet section, with diameter Dₗ, is concentrically surrounded by the nozzle;
given the following physical properties of the transport liquid: surface tension σ with either its vapor or vacuum, electric conductivity κ, density ρ and electrical permittivity of vacuum εₒ, the reference velocity of said transport liquid expressed as
$${( \frac{σκ}{{ρɛ}_{o}} )}^{1 / 3}$$
is equal to or greater than 5.0 meters per second;
given the viscosity μ of the transport liquid, the reference length
$$\frac{{μ}^{2}}{ρσ}$$
is equal to or greater than 0.1 micrometer;
the first electrode is connected to the transport liquid, and the second electrode is placed in front of the outlet section of the transport liquid capillary at a distance H, and a potential difference V between both is applied between 1 and 4 times the voltage
$${( \frac{σ {D}_{l}}{{ɛ}_{o}} )}^{1 / 2} \times Ln ( \frac{H}{{D}_{l}} ) ;$$
which produces an electric field on the transport liquid emerging from the outlet section;
a flow of transport liquid is forced through the transport liquid capillary equal to or less than 100000 times the reference flow expressed as
$$\frac{{σɛ}_{o}}{ρκ} ;$$
a stream of stabilizing gas is discharged concentrically with the transport liquid through the nozzle;
given the density of the stabilizing gas ρ_{g}, the speed of the stabilizing gas ν_{g}, the viscosity of the gas μ_{g} and the opening diameter D_{g} of said discharge section, the Reynolds number
$${Re}_{g} = \frac{{ρ}_{g} {v}_{g} {D}_{g}}{{μ}_{g}}$$
is between 0.1 and 5000;
under all of the foregoing conditions the transport liquid forms at the outlet section of the transport liquid capillary a stable conical capillary meniscus from the apex of which emerges a steady and stable microscopic capillary jet that is a vehicle of the samples previously introduced into the transport liquid.

5. The method according to claim 4, wherein the reference velocity of said
$${( \frac{σκ}{{ρɛ}_{o}} )}^{1 / 3}$$
transport liquid expressed as is greater than 50 meters per second.

6. The method according to claim 4, wherein a potential difference V between 2 and 3 times the voltage
$${( \frac{σ {D}_{l}}{{ɛ}_{o}} )}^{1 / 2} \times Ln ( \frac{H}{{D}_{l}} ) ;$$
is established between the electrodes producing an electric field on the transport liquid emerging from the outlet section.

7. The method according to claim 4, wherein a flow of transport liquid through the transport liquid capillary is less than 500 times the reference flow expresses as
$$\frac{{σɛ}_{o}}{ρκ} .$$

8. The method according to claim 4, wherein in said discharge section, the Reynolds number
$${Re}_{g} = \frac{{ρ}_{g} {v}_{g} {D}_{g}}{{μ}_{g}}$$
is less than 1000 and greater than 10.

9. The method according to claim 4, wherein, given the viscosity μ of the transport liquid, the length
$$\frac{{μ}^{2}}{ρσ}$$
is equal to or greater than 1 micrometer.

10. The method according to claim 4, wherein the samples are introduced into the transport liquid by suspension, solution, or emulsion either directly or by introducing them previously into another liquid which is subsequently mixed or emulsified in the transport liquid.

11. The method according to claim 4, wherein the device further comprises a sample housing capillary, concentric and internal to the transport liquid capillary, configured to house a sample carrier liquid carrying said samples, and wherein the samples are continuously introduced into the transport liquid flowing through the capillary, by means of a sample housing capillary discharging the sample carrier liquid inside the capillary.

12. The method according to claim 11, wherein a defined and convergent stream of the sample carrier liquid is finally generated flowing coaxially through the interior of the microscopic capillary jet entrained by the transport liquid.
